(19) United States
(12) Patent Application Publication
(10) Pub. No.: US 2016/0315682 A1
(43) Pub. Date: Oct. 27, 2016

(54) METHODS AND SYSTEMS FOR WIRELESS CROWD COUNTING

(71) Applicant: THE ROYAL INSTITUTION FOR THE ADVANCEMENT OF LEARNING / MCGILL UNIVERSITY, MONTREAL (CA)

(72) Inventors: XUE LIU, MONTREAL (CA); WEI XI, XI'AN SHAANXI (CN); JIZHONG ZHAO, XI'AN SHAANXI (CN); XIANG-YANG LI, NAPERVILLE, IL (US)

(21) Appl. No.: 15/133,847

(22) Filed: Apr. 20, 2016

Related U.S. Application Data
(63) Continuation of application No. 62/152,230, filed on Apr. 24, 2015.

(51) Int. Cl. H04B 7/06

(52) U.S. Cl. CPC H04B 7/0626

(57) ABSTRACT

Robust crowd counting is an important yet challenging task of interest in a number of applications and is compounded by the fact that crowd behavior is unpredictable. Traditional approaches that tackle these issues are mainly classified into two categories: video based recognition and non-image based localization. However, both suffer inherent drawbacks such as being limited to line-of-sight or requiring people to carry specific electronic devices which limit them even within relatively well controlled environments without considering public locations or rapidly emerging events. Accordingly, it would be beneficial to provide a system that implements a device free crowd counting methodology with no impact on network capacity and/or performance.

### CROSS-REFERENCE TO RELATED APPLICATIONS

This patent application claims the benefit of priority from U.S. Provisional Patent Application 62/152,230 filed Apr. 24, 2015 entitled “Methods and Systems for Wireless Crowd Counting”, the entire contents of which are incorporated herein by reference.

### FIELD OF THE INVENTION

This invention relates to crowd counting and more particularly to methods and systems for device independent wireless crowd counting.

### BACKGROUND OF THE INVENTION

Robust crowd counting is an important yet challenging task. It is of great interest in a number of potential applications, such as guided tour, crowd control, marketing research and analysis, security, etc. Crowd behaviors, however, are often unpredictable. Thus, crowd counting may face various challenges, including, but are not limited to, reliable observation collection, object occlusions, and real-time processing requirement. Traditional approaches that tackle these issues are mainly classified into two categories: video based recognition and non-image based localization.

Video based recognition has been widely deployed in many public places. However, these methods have inherent drawbacks. First, cameras can only work in a line-of-sight pattern, leading many blind areas to the monitoring. Second, the environmental contribution of smoke or lacking of light will severely degrade the visual quality of cameras. Third, objects overlapping further deteriorates the performance. Furthermore, the use of cameras poses privacy concerns. Non-image based solutions typically leverage radio devices to locate objects, such as RFID tags, mobile phones, sensor nodes, etc. These device-based approaches require people to carry certain devices for surveillance, which significantly constrains the usage scope. For a public area with mass people, distributing the device to each person is impractical and costly, and may not be doable under emergent events.

Some device-free approaches have been proposed recently. Most approaches employ received signal strength (RSS) fingerprints for localization, which can be easily obtained for most off-the-shelf wireless devices. However, site survey is time consuming, labor-intensive, and easily affected by environmental dynamics. To avoid site survey, the model based localization approaches use RSS as an indication of signal propagating distance to locate objects. Unfortunately, attenuation models perform poorly due to multipath propagation in complex indoor environments. Exploiting physical layer information for localization and counting in multipath environments has attracted much attention recently but which usually requires specialized equipment (e.g., USRP).

Accordingly, it would be beneficial to provide a solution that overcomes the above drawbacks and provides a device-Free Crowd Counting (FCC) methodology. It would be further beneficial for the solution to not impact network capacity/performance.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to crowd counting and provide methods and systems for device independent wireless crowd counting.

In accordance with an embodiment of the invention there is provided a method comprising:
processing channel state information for a plurality of wireless channels received at a receiver operating according to a predetermined wireless standard in a first predetermined location within an environment from a transmitter operating according to the predetermined wireless standard in a second predetermined location within the environment; and
determining in dependence upon the processed channel state information (CSI) a count of individuals within the environment.

In accordance with an embodiment of the invention there is provided a system comprising;
a receiver operating according to a predetermined wireless standard in a first predetermined location within an environment;
a transmitter operating according to the predetermined wireless standard in a second predetermined location within the environment; and
a microprocessor for executing code stored on a non-volatile memory to perform a method, the method comprising the steps:
   processing channel state information for a plurality of wireless channels received at the receiver transmitted by the transmitter; and
   determining in dependence upon the processed channel state information (CSI) a count of individuals within the environment.

In accordance with an embodiment of the invention there is provided a method comprising:
receiving at a server connected to a network channel state information for a plurality of wireless channels from a receiver connected to the network operating according to a predetermined wireless standard in a first predetermined location within an environment transmitted by a transmitter operating according to the predetermined wireless standard in a second predetermined location within the environment; and
processing the received channel state information to establish a count of individuals within an environment associated with the receiver.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a typical wireless device carried by a crowd member as communicating within a wireless environment;

FIG. 3 depicts the framework for transmitting and receiving data using Orthogonal Frequency Division Multiplexing (OFDM);

FIG. 4 depicts three cases under which moving people affect the signal transmission within a wireless environment;

FIG. 5 depicts experimentally measured Channel State Information (CSI) values from all subcarriers within a wireless environment;

FIG. 6 depicts a simple scenario of multipath effects within a wireless environment;

FIG. 7 depicts CSI measurements for 30 subcarriers with different numbers of moving people;

FIG. 8 depicts CSI measurements for one subcarrier with different numbers of moving people;

FIG. 9 depicts an exemplary workflow according to an embodiment of the invention;

FIG. 10 depicts an inventor established metric with different numbers of people;

FIG. 11 depicts images of experimental scenes and a device employing a crown counting element executing according to an embodiment of the invention;

FIG. 12 depicts CSI sensing range with different values of truncation threshold for a system according to an embodiment of the invention;

FIGS. 13A and 13B depict overall performance of the exemplary workflow in terms of crowd counting errors and inventor established metric according to an embodiment of the invention;

FIG. 14 depicts the variation of the inventor established metric according to an embodiment of the invention with varying dilatation coefficient;

FIG. 15 depicts estimation results for a system according to an embodiment of the invention with different numbers of characteristic data sequences;

FIG. 16 depicts the impact of receiver-transmitter separation on the error for a system according to an embodiment of the invention;

FIG. 17 depicts the impact of crowd distribution on the estimation error for a system according to an embodiment of the invention;

FIG. 18 depicts the impact of speed of motion on the estimation error for a system according to an embodiment of the invention;

FIGS. 19A and 19B depicts the scalability of a system according to an embodiment of the invention;

FIG. 20 depicts the inventor established metric and estimation error versus the number of people for a system according to an embodiment of the invention; and

FIGS. 21A and 21B depict a comparison between a system according to an embodiment of the invention with a prior art methodology.

### DETAILED DESCRIPTION

The present invention is directed to crowd counting and more particularly to methods and systems for device independent wireless crowd counting.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

1: Exemplary Environment and Device Configuration

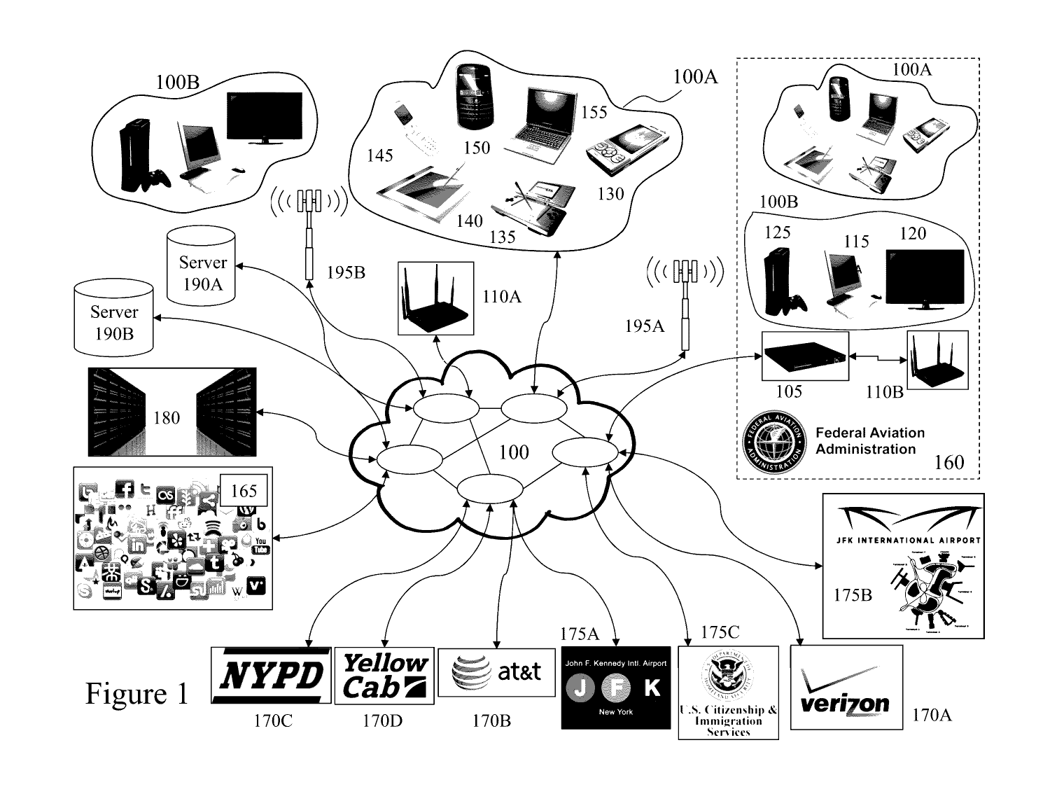

Referring to FIG. 1 there is depicted a network environment 100 within which embodiments of the invention may be employed supporting device-Free Crowd Counting (FCC) systems/applications/platforms (FCCSAPs) (FCCSAPs) according to embodiments of the invention. Such FCCSAPs, for example supporting multiple channels and dynamic content. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. Federal Aviation Administration™, within which other first and second user groups 100A and 100B respectively are present. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are Social Networks (SOCNETS) 165, first and second wireless provider resources 170A and 170B respectively, e.g. Verizon™ and AT&T™, an authority 170C, e.g. New York Police Department™, service provider 170D, e.g. Yellow Cabs and first to second location entities 175A to 175C respectively, e.g. John F Kennedy (JFK) airport transit, JFK Airport Authority, and US Citizenship & Immigration, as well as first and second servers 190A and 190B together with others, not shown for clarity. First and second servers 190A and 190B may host according to embodiments of the inventions multiple services associated with a provider of rating systems and rating applications/platforms (FCCSAPs); a provider of a SOCNET or Social Media (SOME) exploiting FCCSAP features; a provider of a SOCNET and/or SOME not exploiting FCCSAP features; a provider of services to PEDS and/or FEDS; a provider of one or more aspects of wired and/or wireless communications; an Enterprise 160 exploiting FCCSAP features; license databases; content databases; schedule databases; safety libraries; service provider databases; websites; and software applications for download to or access by FEDs and/or PEDs exploiting and/or hosting FCCSAP features etc. First and second primary content servers 190A and 190B may also host for example other Internet services such as a search engine, financial services, third party applications and other Internet based services.

Accordingly, a user may exploit a PED and/or FED within an Enterprise 160, for example, and access one of the first or second primary content servers 190A and 190B respectively to perform an operation such as accessing/downloading FCC data, managing/adjusting aspects of an enterprise based upon FCC data, post FCC data to a SOCNET/SOME. They may alternatively access an application which provides FCCSAP features according to embodiments of the invention; execute an application already installed providing FCCSAP features; execute a web based application providing FCC SAP features; or access content. Similarly, a user may undertake such actions or others exploiting embodiments of the invention via a PED or FED within first and second user groups 100A and 100B respectively via one of first and second cellular APs 195A and 195B respectively and first Wi-Fi nodes 110A.

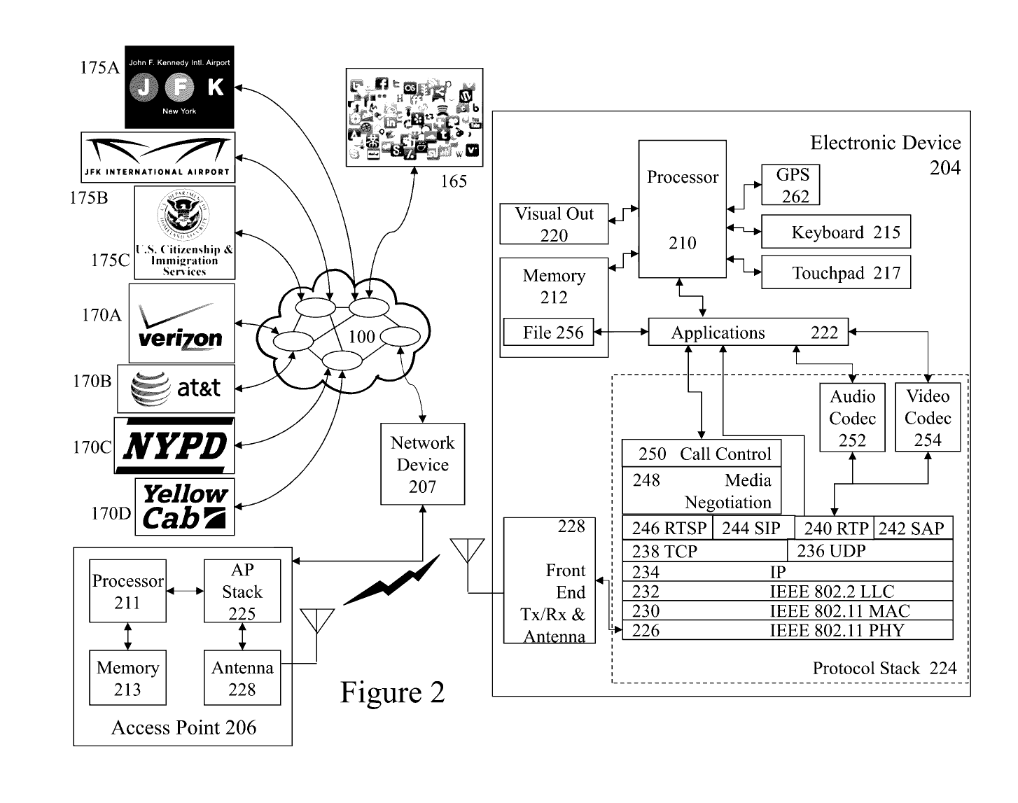

Now referring to FIG. 2 there is depicted an electronic device 204 and network access point 207 supporting FCCSAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a wireless hot spot or node, one or more access points (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein SOCNETS 165, first and second wireless provider resources 170A and 170B respectively, e.g. Verizon™ and AT&T™, an authority 170C, e.g. New York Police Department™, service provider 170D, e.g. Yellow Cabs and first to second location entities 175A to 175C respectively, e.g. John F Kennedy (JFK) airport transit, JFK Airport Authority, and US Citizenship & Immigration, as well as first and second servers 190A and 190B together with others, not shown for clarity.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include a display, visual output element 220, for example an LCD display, coupled to any of processors 210. Electronic device 204 may also include a keyboard 215 which may for example be a physical keyboard or touchscreen allowing the user to enter content or select functions within one of more applications 222. The one or more applications 222 that are typically stored in memory 212 and are executable by any combination of processors 210. Electronic device 204 may also include GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, electronic device 204 may in essence be a stripped down smartphone 150, for example, or a dedicated FCC node. Some electronic devices 204 may be receivers only, others transmitter only, and others transceivers. Some electronic devices 204 will support wireless communications on a first wireless standard and FCC activities upon a second wireless standard. In other embodiments of the invention the FCC functionality may be integrated to an access point 206 or network device 207 according to the environment, cost, performance requirements etc. As described and depicted below in respect of embodiments of the invention within an area to be monitored and device-Free Crowd Counting to be performed will have a plurality of wireless devices deployed.

Considering FIGS. 1 and 2 then examples of use of the FCC data derived within an area, for example considering JFK Airport, may include dynamically adjusting check-in personnel to reflect the queues/activity around the check-ins, adjusting the number of immigration personnel based upon the numbers of people arriving at departure/entry points, adjusting distribution of yellow cabs around the multiple terminals to reflect user requirements, advising emergency authorities of approximate locations/numbers of individuals immediately before or during an emergency, etc.

2: Theoretical Analysis and Observation

In radio communications, the emitted electromagnetic waves often do not reach the receiving antenna directly due to the blocking of obstacles in the line-of-sight path. In fact, the received waves are a superposition of waves coming from all directions due to reflection, diffraction, and scattering caused by furniture, people, and other obstacles. This effect is known as multipath propagation.

After extensive measurements of the envelope of the received signal in urban and suburban areas, i.e., in regions where the line-of-sight component is often blocked by obstacles, the Rayleigh process was suggested as suitable stochastic model process. In rural regions, however, the line-of-sight component is often a part of the received signal, so that the Rice process is the more suitable for these channels.

Rician fading is a stochastic model for radio propagation anomaly caused by partial cancellation of a radio signal by itself when the signal arrives at the receiver by several different paths (hence exhibiting multipath interference), and at least one of the paths is changing (lengthening or shortening). Rician fading occurs when one of the paths, typically a line of sight signal, is much stronger than the others. In Rician fading, the amplitude gain is characterized by a Rician distribution. The Rice factor, K, is defined as the ratio of the specular power to scattered power. When K=0 the channel exhibits Rayleigh fading, and when K=∞0 the channel does not exhibit any fading at all.

$$h = {h}_{d} ( t ) + {h}_{l} ( t ) = \sqrt{\frac{{σ}_{h}^{2}}{K + 1}} {\sum }_{i = 1}^{M} {e}^{{jφ}_{i}} + \sqrt{\frac{K {σ}_{h}^{2}}{K + 1}} {e}^{{jφ}_{0}} \qquad ( 1 )$$

In the current widely used Orthogonal Frequency Division Multiplexing (OFDM) systems, which are depicted in FIG. 1 for transmit and receive paths within PEDs/FEDs/network nodes etc. the Channel State Information (CSI) can reveal the effect of scattering, fading and power decay with distance. This information describes how a signal propagates from the transmitter to the receiver and represents some other combined effect.

In a narrowband fiat-fading channel, the OFDM system in the frequency domain is modeled by Equation (2) where Y and X represent the receive and transmit vectors respectively and H and N are the channel matrix CSI and noise vector respectively. Therefore, the estimated value of H can be expressed by Equation (3). Accordingly, the CSI is sensitive to the change of the environment. If someone moves between two communication parts, the CSI will have undergone changes.

$$\begin{matrix}Y = H \cdot X + N & ( 2 ) \\ \hat{H} = \frac{Y}{X} & ( 3 )\end{matrix}$$

According to experiments performed by the inventors they employed Intel™ 5300 WiFi wireless net card and Linux 802.11n CSI Tool kit to obtain 30 pairs of amplitude and phase CSI values of each packet within an experimental network. A series of experiments were conducted to establish the relationship between CSI measurements and the number of moving people. Accordingly, a pair of laptops were positioned 5 meters away from each other. One laptop continued to send packets to the other whilst people walked around in the active area. Accordingly, as depicted in FIG. 2, these individuals can impact the CSI based upon their location. The most obvious, denoted Case I in FIG. 4, is that the individual is in the region between the transmitter (Tx) and receiver (Rx). The other areas are those regions outside the direct link around the Tx and Rx that give rise to variations in the other indirect paths between the Tx and Rx.

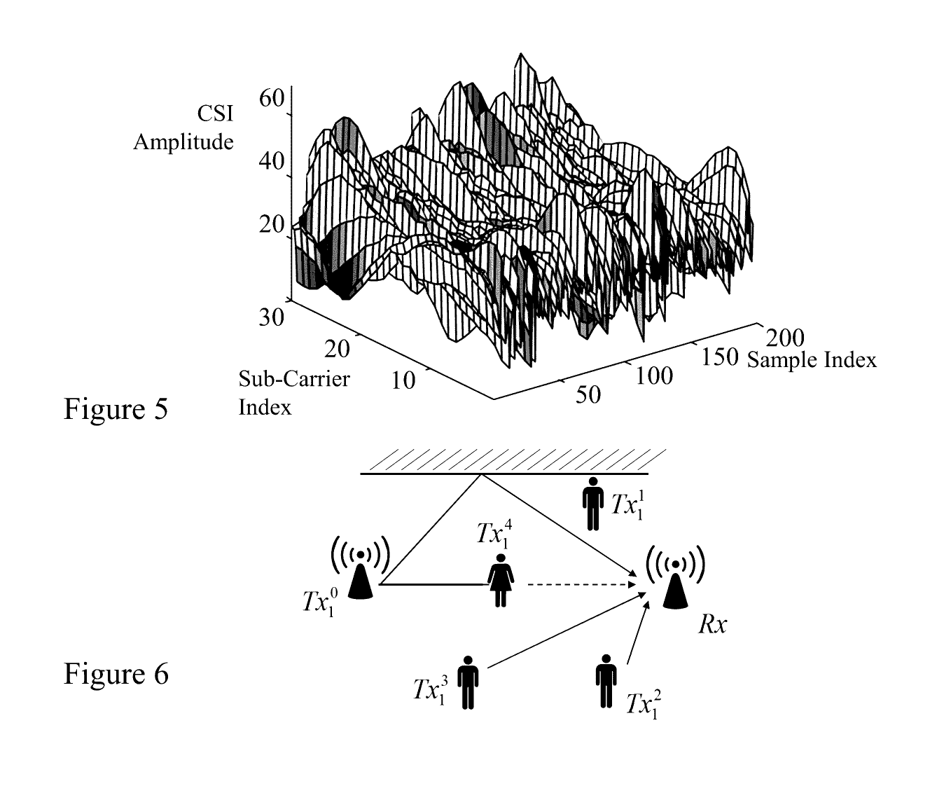

Based upon these measurements FIG. 5 shows the variation of CSI amplitude from 30 subcarriers over time which looks similar to the Rician fading. Referring to FIG. 4 there is shown schematically how the people influence the signal propagation. The black solid lines demonstrate the transmission paths from Tx₁⁰ to the Rx in the case of a stationary individual. The receive vector is denoted as Y⁰ and the corresponding CSI is denoted as H⁰. The H⁰ can be considered a constant under certain scenarios, e.g. no people. Each individual may reflect or block signal and cause the receive vector to be either strengthened or weakened. Each individual can be regarded as a virtual antenna, and the receive vectors from these virtual antennas are denoted as Yⁱ (i=1,2,3 . . . ). The virtual antennas have several properties. The first is that the Rx cannot distinguish the signals from Tx₁⁰ and Tx₁ⁱ because all the signals transmitted from all the virtual antennas actually originate from Tx₁⁰, and the transmit vectors Xⁱ are the same and equal to X⁰ from Tx₁⁰. Secondly, Yⁱ obeys normal distribution (N(μₙ, σₙ²), where μₙ and σₙ² are functions that depend on the number of Tx₁ⁱ. In other words, Yⁱ is independent and identically distributed with the condition of the same number of Yⁱ.

Accordingly, the CSI between Rx and Tx can be estimated by Equation (4). Applying a variance operator to the two sides of Equation (4) yields Equation (5). Accordingly, σₙ² decreases as the number of Tx₁ⁱ increases, which is caused through intercepting mutually. The blocking inhibits the effect of a virtual antenna and the range of Yⁱ is reduced. Accordingly, the probability of blocking, S(n), can be calculated using Equation (6) where m is the number of Yⁱ that the area can contain, Kₙ is the number of choices that there is blocking when the number of Yⁱ is n . S(1)=0. S(n) increases exponentially with Yⁱ. The σₙ² will convex reduce with the S(n) growth until S(n)=1. In other words, D(Ĥ) will convex increase with a growing number of moving people.

$$\begin{matrix}\hat{H} = \frac{Y}{X} = \frac{{Y}^{0} + {\sum }_{i = 1}^{n} {Y}^{i}}{X} = {\hat{H}}_{0} + \frac{1}{X} {\sum }_{i = 1}^{n} {Y}^{i} & ( 4 ) \\ D ( \hat{H} ) = \frac{n {σ}_{n}^{2}}{{X}^{2}} & ( 5 ) \\ S ( n ) = \frac{{K}_{n}}{{C}_{m}^{n}} ⇒ \{ \begin{matrix}S ( n + 1 ) > \frac{{K}_{n} {C}_{m - n}^{1}}{{C}_{m}^{n + 1}} \\ \frac{S ( n + 1 ) - S ( n )}{S ( n )} > n\end{matrix} & ( 6 )\end{matrix}$$

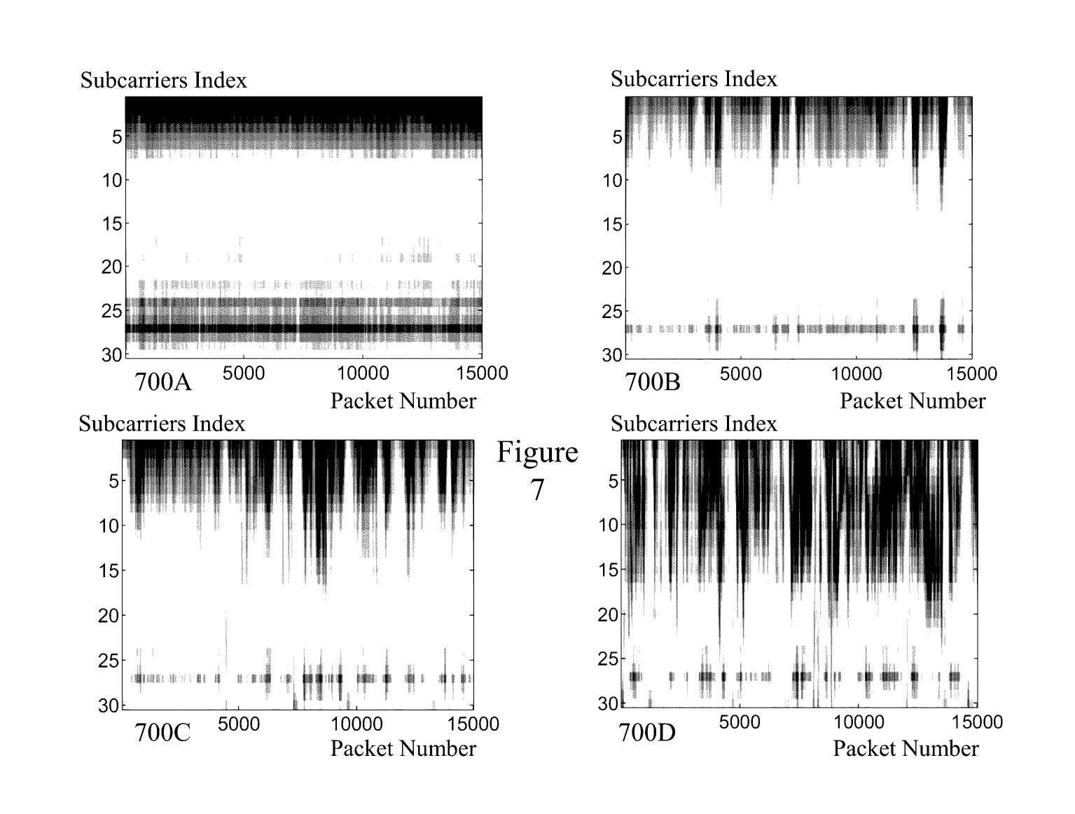

Now referring to FIG. 7 there are depicted CSI measurements for 30 subcarriers in Case I as depicted in FIG. 4 wherein the individual(s) are between the transmitter and receiver. The horizontal axis denotes the packages index, whilst the vertical axis denotes the subcarrier index, and different shades denote the different values of CSI reading. First to fourth graphs 700A to 700D respectively demonstrate the variation in CSI amplitude when 0, 2, 4, and 6 people are walking between the Rx and Tx. It is evident that the CSI readings are changing all the time, whether there are moving people or not. However, the readings distribute more widely and change more rapidly when there are more moving people. Referring to FIG. 8 there is depicted the observed CSI measurements for one subcarrier in Case 1 to give more detailed observations. Accordingly, the inventors established that with the appropriate quantifiable index to characterize the variations within the CSI measurements that it becomes possible to use CSI to count the number of individuals, i.e. crowd count.

3. Methodology

Accordingly, it would be evident that the inventive approach provides a device-Free Crowd Counting methodology. Within the ensuing description the details of a FCC system architecture according to an embodiment of the invention are presented together with details of the system modules.

3.1: System Design

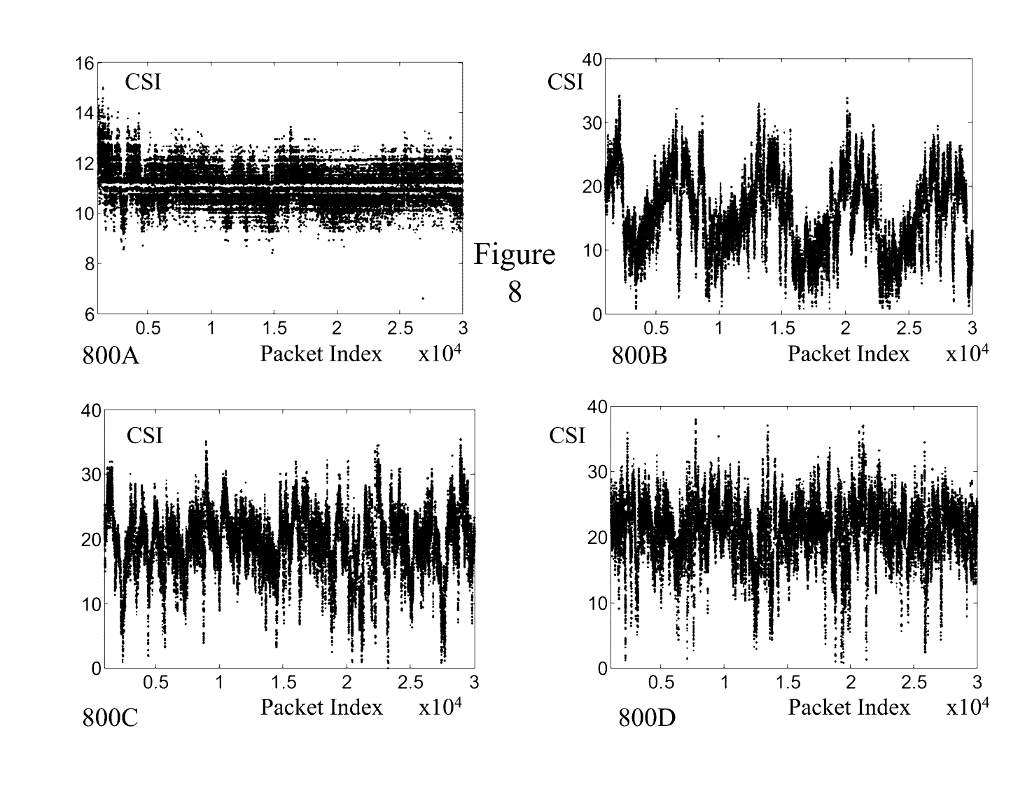

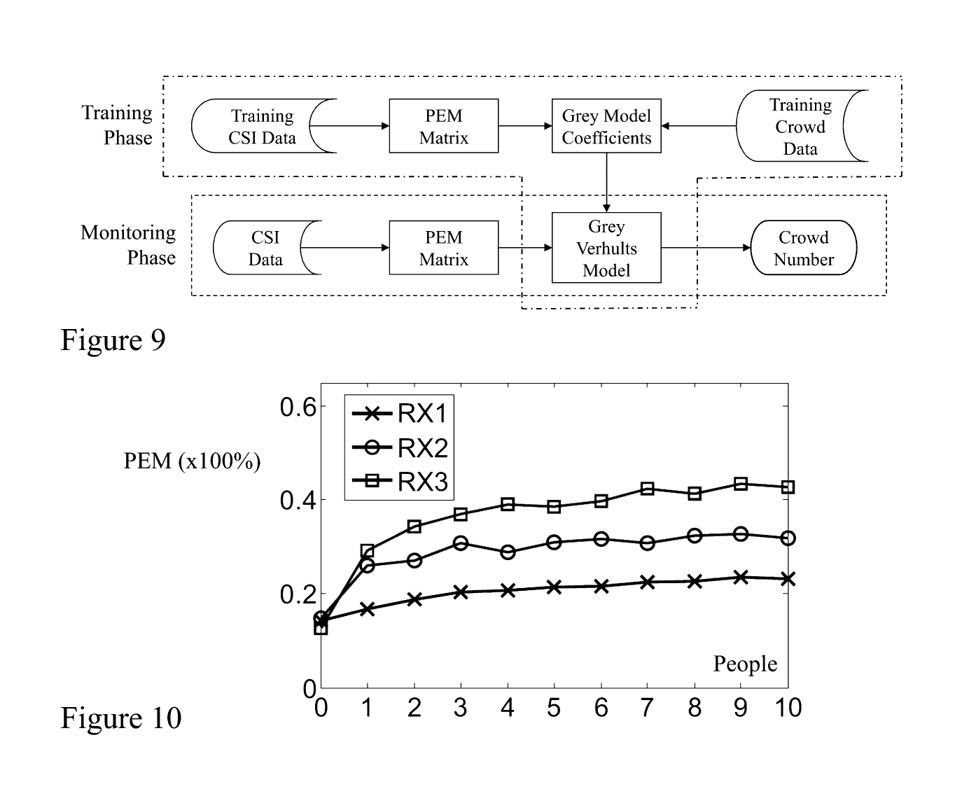

Referring to FIG. 9 there is depicted an overview of the system architecture. The depicted modules of the proposed methodology according to an embodiment of the invention can be implemented within an application server that collects samples from the monitoring points and processes them. The system works in two phases, an offline phase and a monitoring phase.

During an offline phase, during which the system studies the CSI values when no or a few of people are walking inside the area of interest, in order to construct what the inventors refer to as a “training profile” for each for each stream. The profiles of all streams are constructed concurrently, for example, during this offline phase which may be relatively brief. Subsequently, a monitoring phase is established wherein the system collects readings from the monitoring points and decides for how many people there is activity within the area. It also updates the stored training profile so that it can adapt to environmental changes. Finally, a decision refinement procedure is applied to further enhance the accuracy.

Within an initial prototype system for the basic FCC system, the inventors employed 4 laptop computers, each with an Intel 5300 Network Interface Card (NIC) representing a common NIC supporting IEEE 802.11a/b/g and IEEE 802.11Draft-N1 wireless protocols in both the 2.4 GHz and 5.0 GHz spectrum region. One laptop continues to broadcast beacon messages, and the other three laptops work as receivers to measure the CSI values of the channel fadings.

3.2: CSI Profile Construction

The training phase and monitoring phase both contain a common component to learn the behavior of the signal readings in the monitoring area. This feature for system operation should be resistant to possible environmental changes that may affect the stored data. In addition, the selected feature should also be sensitive to the human motion to enhance the detection accuracy.

As mentioned above, moving people can influence the transmission channel, change the signal paths and cause CSI variation. The more people moving in the area, the more signal transmission paths will be changed. Referring to FIG. 10 there is depicted the change of time-adjacent CSI amplitude from which it can be see that this becomes larger as the number of moving people increases. When the CSI measurements during a time period are plotted as a two-dimensional diagram, the distance of time-adjacent points indicates the variation of CSI profiling. A major challenge is to formulate the relationship between CSI variation and the number of people in the crowd where the obstacle is how to describe the variance of CSI. If we select a large size sample space, the system performance would suffer the impact of the long sampling time. Furthermore, the average variance is useless when the crowd number changes very frequently as may be the case in a large number of potential application. In contrast, the variance is not statistically significant when the sample size was too small. Therefore, it is important to establish a metric which has the capability of mirroring the current CSI variance.

The inventors established that when the number of points are expanded beyond a certain size then they overlap with their neighboring points. This overlapped area varies inversely to the intensity of CSI variation. Accordingly, the inventors proposed a metric known as the Percentage of non-zero Elements in the dilated CSI Matrix (PEM), to indicate variation of CSI profiling. An exemplary algorithm for generating as shown in Algorithm 1 below. It is generally divided into 3 steps:

(1) transform the CSI amplitude values into two-dimensional matrix;

(2) dilate the matrix; and

(3) count the non-zero elements.

Within Algorithm 1 C_{D} is the barriered CSI results, S is the number of sub-carriers, P is the number of packets, C_{U} and C_{L} are the maximum and minimum value of CSI measurements, M_{C} the number of rows of matrix, D which is the dilatation coefficient.

Algorithm 1: Dilatation-Based Crowd Profiling

```
Input C_{D};S;P;C_{L};C_{U};M_{C};D
Output P
For i = 1 : S do
  For j = 1 : P do
    $k = ⌊ \frac{{C}_{D} [ i ] [ j ] - {C}_{L}}{{C}_{U} - {C}_{L}} \cdot ( {M}_{C} - 1 ) ⌋ + 1 ;$
    For u = −D : D do
      For v = −D : D do
        If 1 ≦ j + u ≦ P & 1 ≦ k + v ≦ M_{C} then
          M[i + u][j + v] = 1
        End
      End
    End
  End
  For l = 1 : P do
    For m = 1 : M_{C} do
      Ones = Ones + M[l][m];
    End
  End
  P(i) = Ones/(P × M_{C});
End
```

First, each element in the M_{C}×P matrix M₀ is initialized to “0”. The CSI reading C_{D}[i][j] is converted into integers k by

$$k = ⌊ \frac{{C}_{D} [ i ] [ j ] - {C}_{L}}{{C}_{U} - {C}_{L}} \cdot ( {M}_{C} - 1 ) ⌋ + 1 ;$$

and then the elements in row k and column j in M₀ is set to “1”. There is a “1” in each column, and the rest are “0”s. Obviously, the variance of the row numbers of non-zero elements between adjacent columns becomes larger, when the CSI readings take dramatic turns.

Secondly, the elements around “1” are set to “1”s, which is called matrix dilation. After dilation, the CSI matrix M₀ is transformed into dilated CSI matrix M. There is less overlap of dilated elements when the CSI reading are changing more sharply. That is, significant change of CSI usually comes along with more “1”s.

Finally, the percentage P[i] (which is the PEM of i^{th} subcarrier) of non-zero elements in the dilated CSI matrix of each subcarrier can be calculated. The larger the overlap areas of dilated points are, the low percentage of non-zero elements in the dilated CSI matrix. So we can employ P[i] to indicate the number of moving people within the area being characterised. Now referring to FIG. 10 it can be seen that there exists a monotonous relationship between P[i] and the people count. P[i] increases with the growing number of moving people.

Based on this monotonous relation, we can gather a CSI fingerprint to determine the function between PEM and people count when a few people walk in the area, and then estimate numbers when there are more moving people.

3.3: CSI Profile Fitting

The purpose of a CSI Profile Construction Module is to construct a normal profile and capture the CST characteristics. These characteristics can then be used by other modules to count crowd. As shown in FIG. 10, we can see that there are some quasi-monotonous relationships between the crowd number and the corresponding PEM. PEM is non-negative, and its growth is a saturation process. The inventors within an embodiment of the invention the Grey Theory to describe them in combination with the Verhulst model to limit the whole development for a real system. The raw data series is assumed to be given by Equation (7) where n is the number of characteristic data sequences. The Grey Verhulst Model can be constructed by establishing a first order differential equation for X⁽¹⁾(k) as given by Equation (8) where the parameters a, and b are the developing coefficient and grey action quantity, respectively. In practice, parameters a and b can be obtained by using the least square method as given by Equations (9), (10A) and (10B) where Z⁽¹⁾ is the Mean Generation of Consecutive Neighbors Sequence (MGCNS)\ defined in Equations (11) where \hat{x}⁽¹⁾ transforms as given by Equation (12) where \hat{x}⁽¹⁾(k) (k≦n) are fitted sequences, and \hat{x}⁽¹⁾(k)(k>n) are the forecast values. Since the initial sequence X⁽⁰⁾ is a saturated sequence, it can be used instead of X⁽¹⁾.

$$\begin{matrix}{X}^{( 0 )} = \{ {x}^{( 0 )} ( 1 ) , {x}^{( 0 )} ( 2 ) , … , {x}^{( 0 )} ( n ) \} & ( 7 ) \\ \frac{d {X}^{( 1 )}}{d t} + {aX}^{( 1 )} = {b ( {X}^{( 1 )} )}^{2} & ( 8 ) \\ {[ a , b ]}^{T} = {( {B}^{T} B )}^{- 1} {B}^{T} Y & ( 9 ) \\ B = [ \begin{matrix}{z}^{( 1 )} ( 2 ) & {( {z}^{( 1 )} ( 2 ) )}^{2} \\ {z}^{( 1 )} ( 3 ) & {( {z}^{( 1 )} ( 3 ) )}^{2} \\ … & … \\ {z}^{( 1 )} ( n ) & {( {z}^{( 1 )} ( n ) )}^{2}\end{matrix} ] & ( 10 A ) \\ Y = [ \begin{matrix}{x}^{( 0 )} ( 2 ) \\ {x}^{( 0 )} ( 3 ) \\ … \\ {x}^{( 1 )} ( n )\end{matrix} ] & ( 10 B ) \\ {z}^{( 1 )} ( k ) = \frac{1}{2} ( {x}^{( 1 )} ( k ) + {x}^{( 1 )} ( k - 1 ) ) k = 2 , 3 , … , n & ( 11 ) \\ {\hat{x}}^{( 10} ( k ) = \{ \begin{matrix}\frac{{ax}^{( 1 )} ( 1 )}{{bx}^{( 1 )} ( 1 ) + ( a - {bx}^{( 1 )} ( 1 ) ) {e}^{a ( k - 1 )}} & k = 2 , 3 , … \\ {x}^{( 1 )} ( 1 ) & k = 1\end{matrix} & ( 12 )\end{matrix}$$

3.4: Crowd Counting

According to Grey Theory, a smaller |a| is better for forecasting and accordingly the inventors have decomposed the crowd estimation into two steps:

Step 1: Each receiver, Rx, generates its own developing coefficient aᵢ, and grey action quantity bᵢ and calculates its estimating number, \hat{n}ᵢ, as given by Equation (13).

Step 2: The system obtains the final estimation through weighted average algorithm if there are N Rx devices, such as by using Equation (14).

$$\begin{matrix}{num}_{i} {\hat{n}}_{i} = ln \frac{\frac{{a}_{i} {x}^{( 1 )} ( 1 )}{{PEM}_{i}} - {b}_{i} {x}_{i}^{( 1 )} ( 1 )}{( {a}_{i} - {b}_{i} {x}_{i}^{( 1 )} ( 1 ) ) {e}^{{a}_{i}}} + 1 & ( 13 ) \\ {E}_{NUM} = \frac{{\sum }_{1}^{N} ( {\hat{n}}_{i} \times \frac{1}{\vert {a}_{i} \vert} )}{{\sum }_{1}^{N} ( \frac{1}{\vert {a}_{i} \vert} )} & ( 14 )\end{matrix}$$

3.5 Scalability

Since each receiver can only estimate the number of moving people within a certain range, the scalability of FCC should be considered to work well in large scale scenes. Intuitively, more devices can be deployed as the grid to cover the larger monitoring regions. However, this can lead to a new problem in that there may be mutual interference between two neighboring grids. Therefore, it is necessary to eliminate distractions.

For narrow-band systems, these reflections will not be resolvable by the receiver when the bandwidth is less than the coherence bandwidth of the channel. Fortunately, the bandwidth of 802.11n waveforms is 20 MHz (with channel banding, the bandwidth could be 40 MHz), which provides the capability of the receiver to resolve the different reflections in the channel. We propose a multipath mitigation mechanism that can distinguish the line of sight (LOS) signal or the most closed N-LOS from other reflections in the expectation of eliminating distractions from a distant.

The commonly used profile of multipath channel in the time domain is described as follows. In practice, OFDM technologies are efficiently implemented using a combination of fast Fourier Transform (FFT) and inverse fast Fourier Transform (IFFT) blocks. The 30 groups of CSI represent the channel response in frequency domain, which is about one group per two subcarriers. With IFFT processing of the CSI, we can obtain the channel response in the time domain, i.e., h(t). Due to the bandwidth limitation, we may not be able to distinguish each signal path, but multiple signal clusters. Therefore, we keep the first part of h(t) which includes the LOS and a few of NLOS signal paths, and filter out the residual clusters using a truncation window. The first part time duration is determined by setting the truncation threshold α as shown in Algorithm 2 wherein Cᵣ means the raw CSI measurement of i^{th} subcarriers and j^{th} packet.

Algorithm 2: Truncation Denoise Procedure

```
Input Cᵣ; S; P; α
Output C_{d}
np = 2^{┌log}₂ length(Cᵣ)┐
For i = 1 : P do
    tmp[S] = IFFT(Cᵣ[S][i], np)
    For j = └S * α┘: S do
        tmp[j] = 0
    End
    C_{d}[S][i] = FFT(tmp[S], np)
End
```

In doing so, we expect to mitigate the estimation error introduced by the mutual interference between two neighboring grids. After the time domain signal processing, we re-obtain the CSI using FFT.

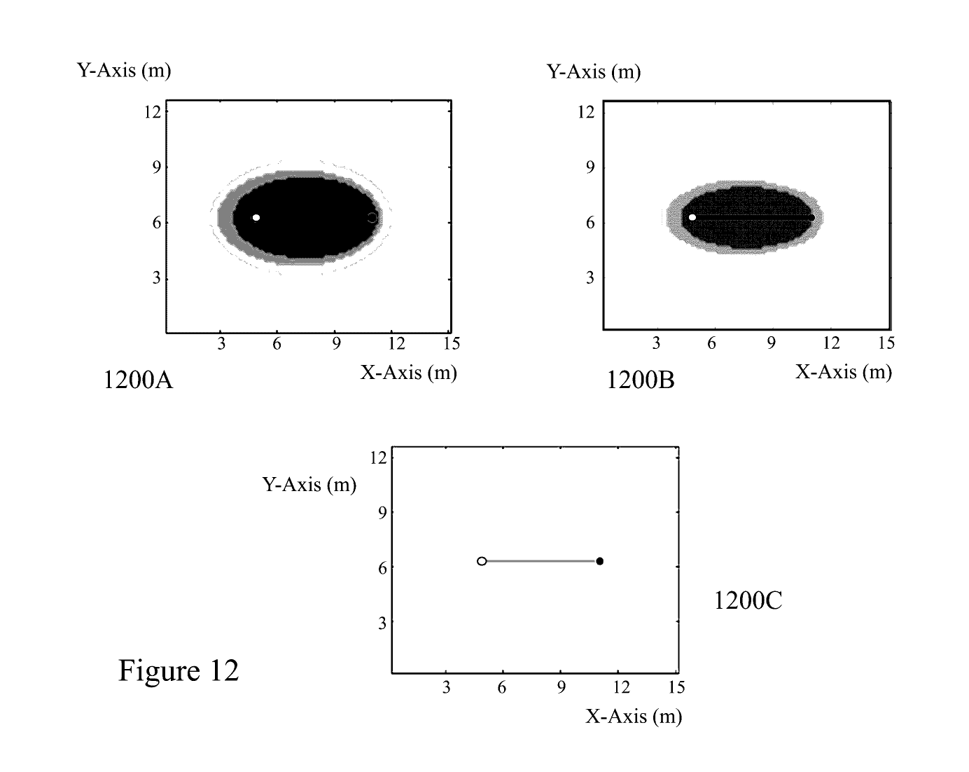

The inventors conducted a set of experiments to evaluate the impact of truncation threshold α in all three cases shown in FIG. 4. FIG. 12 shows the contour of PEM for varying truncation threshold α wherein in first to third plots 1200A to 1200C α=1;0.5;0.3 respectively. The darker color indicates a larger PEM. The dots represent the Tx and Rx respectively. It is interesting to note that the CSI sensing range is asymmetrical. From FIG. 12 we can see that it is more sensitive around the Tx than the Rx, and that the sensing range around the Tx is larger than around the Rx. With decreased α, the sensing range is reduced. When α=0.3, the effective sensing range is reduced to the area between Rx and Tx. In this case, the moving people in adjacent regions cannot effect the PEM, which can efficiently eliminate distractions among adjacent regions.

4. Experiment Results

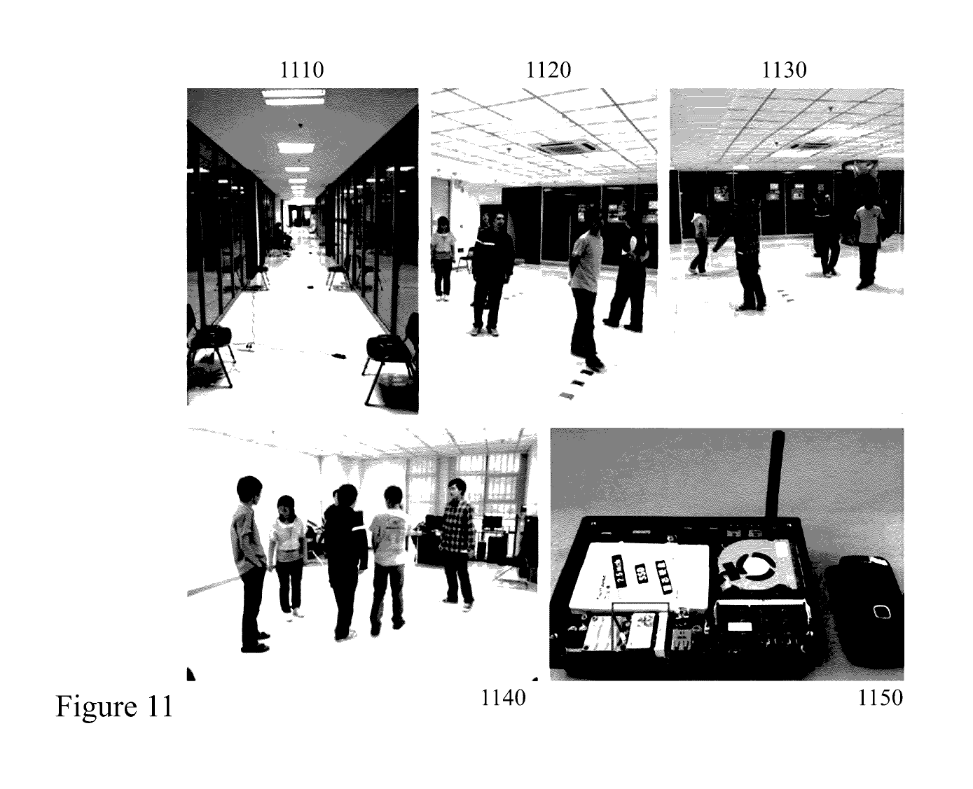

The methodology and algorithms described in Section 3 above in respect of embodiments of the invention are described below in respect of experimental scenarios and metrics for performance evaluation. The initial real world experiments to demonstrate the performance and robustness of FCC in different scenarios are depicted by first to fourth images 1110 to 1140 respectively in FIG. 11 together with a device embodying the invention within an IEEE 802.11n node in fifth image 1150 in FIG. 11.

4.1: Overall Performance

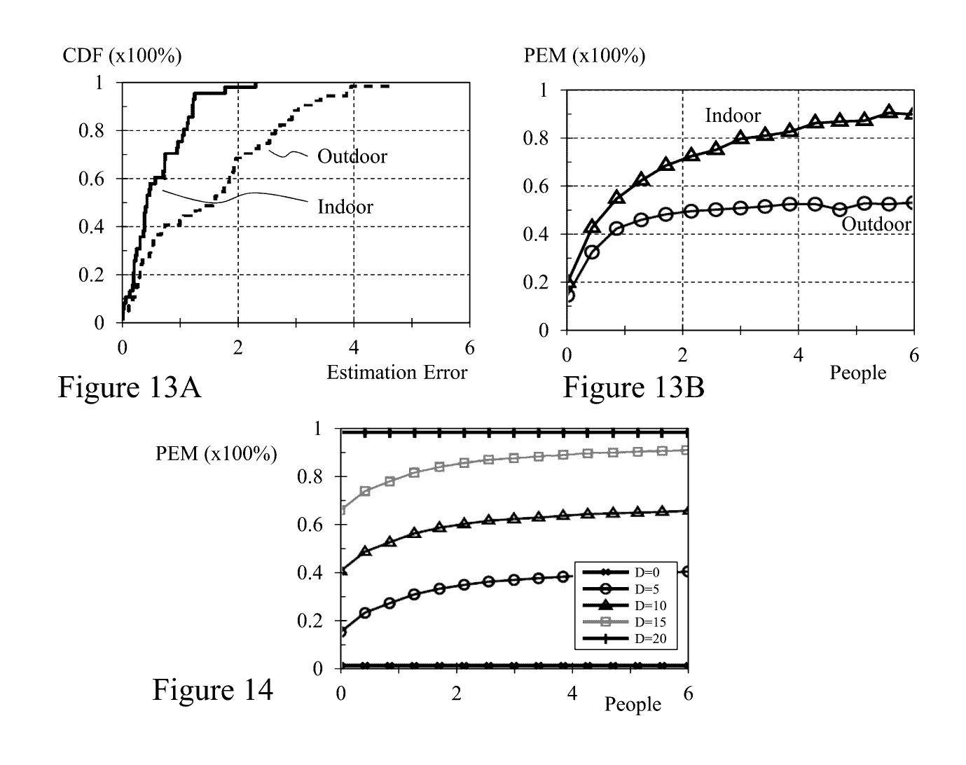

Referring to FIG. 13A the cumulative distribution of crowd counting errors in indoor and outdoor environments is depicted where the X-axis represents the difference between the actual number of moving people and the estimation value, while the Y-axis presents the CDF percentage. It is evident that the FCC works well in both indoor and outdoor environments, although better in the former where greater than 98% of the estimation errors are less than 2 individuals in indoor environments, while about 70% errors are 2 individuals in outdoor environment. This is because there are more obvious multipath effects in indoor environments than there are outdoors. In high multipath environments the movement of people is more likely to cause the radio channel changes.

Referring to FIG. 13B there is plotted the PEM for the two different kinds of scenes. In each instance the PEM is increasing with the increasing number of people, especially in indoor environments. In the outdoor environment, the curve's slope becomes significantly lower when the number of people increases above 10.

4.2: Impact of Dilatation Coefficient

Since PEM is calculated based upon the dilated CSI matrix M, then the impact of the dilatation coefficient should be evaluated. FIG. 14 depicts the variation of PEM with varying different dilatation coefficient D. When D=0, the PEM is constant with the increases in the number of people. This is because no matter how the CSI changes over time, there are no overlapping parts or components since each column only has one non-zero element before dilatation. When D=20, the PEM also remains constant. This is because almost all the elements are set to “1” when the dilatation coefficient is large or too big. In other words, the dilatation covers the variance. When D=5 or D=10,15 then there is a monotonically increasing relationship between PEM and the number of people. Accordingly, in subsequent experiments the inventors set D=10.

4.3: Performance of Verhulst Model

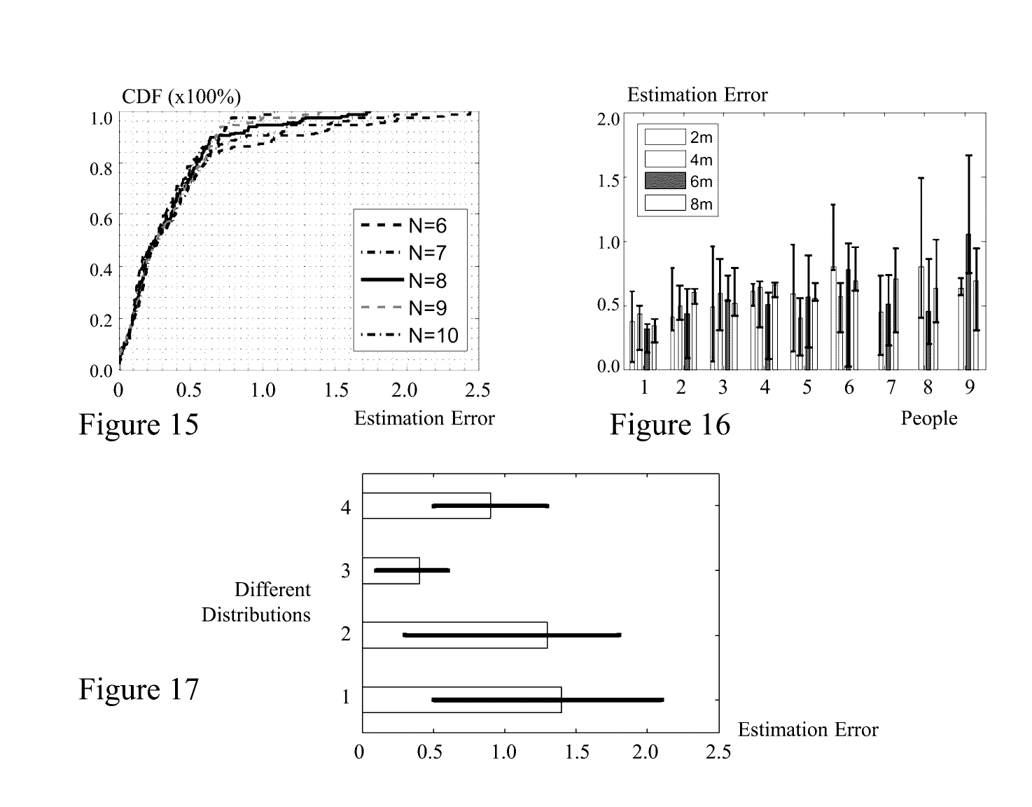

A series of experiments were made to evaluate the performance of the Verhulst Model with different numbers of characteristic data sequences. These estimation results are presented in FIG. 15. We use 0−N people's characteristic data sequence in training phase to estimate the number of moving people in monitoring phase where the people is 0≦N≦30. The Verhulst model is an ad-hoc model. It is an equation chosen to fit data, which is a very good model for the number of people growth. The maximum estimation error is approximately 2.5, and it reduces to approximately 1.1 with growing N. Since the parameters a and b are calculated by the least square estimate method, a larger N means more equations, which will obtain a better a and b, and have increasingly accurate fitted sequences. Generally speaking, the Verhulst model can be taken as a long term forecast when |a|<0.3, and taken as a short term forecast when 0.3<|a|<0.7.

4.4: Impact of Communication Distance

The inventors also evaluated the impact of the distance between Tx and Rx with respect to the accuracy of the FCC system according to embodiments of the invention. The system was evaluated to estimate the number of people walking between a pair of laptops with different distances between the pair of laptops. Due to space limitation, the communication distance between two laptops could only be increased from an initial 2 meters (approximately 6 feet 6 inches) to 8 meters (approximately 26 feet). The estimation error with different communication distances is plotted in FIG. 16 as a function of the number of people. It is evident from this that the estimation error is uncorrelated to communication distance, as long as the communication distance is less than a certain threshold. Importantly, this implies that the methodology allows for a more flexible deployment mechanism in order to adapt to various indoor layouts without reducing the estimation accuracy.

4.5: Impact of Distribution

The inventors also considered how crowd distribution impacted the estimation numbers obtained with an embodiment of the invention. There were four cases valuated:
Case 1: 12 people split into 2 groups, one moving near Rx₁ and the other move near Rx₃;
Case 2: 12 people split into 2 groups, one moving near Tx and the other moves near Rx₂;
Case 3: 12 people move randomly in the scenario; and
Case 4:12 people split evenly into 3 groups with 4 people each moving near Tx, Rx₁, and Rx₃ respectively.

Referring to FIG. 17 there is depicted the impacts of these different distributions. The X and Y axes respectively represent the estimation error and the four cases. The estimation error in case 3 is less than other three cases. This is because that the crowd is most similar to a stochastic distribution in case 3. Although the distribution affects estimation accuracy, the maximum average error is less than 1.5.

4.6 Impact of Moving Speed

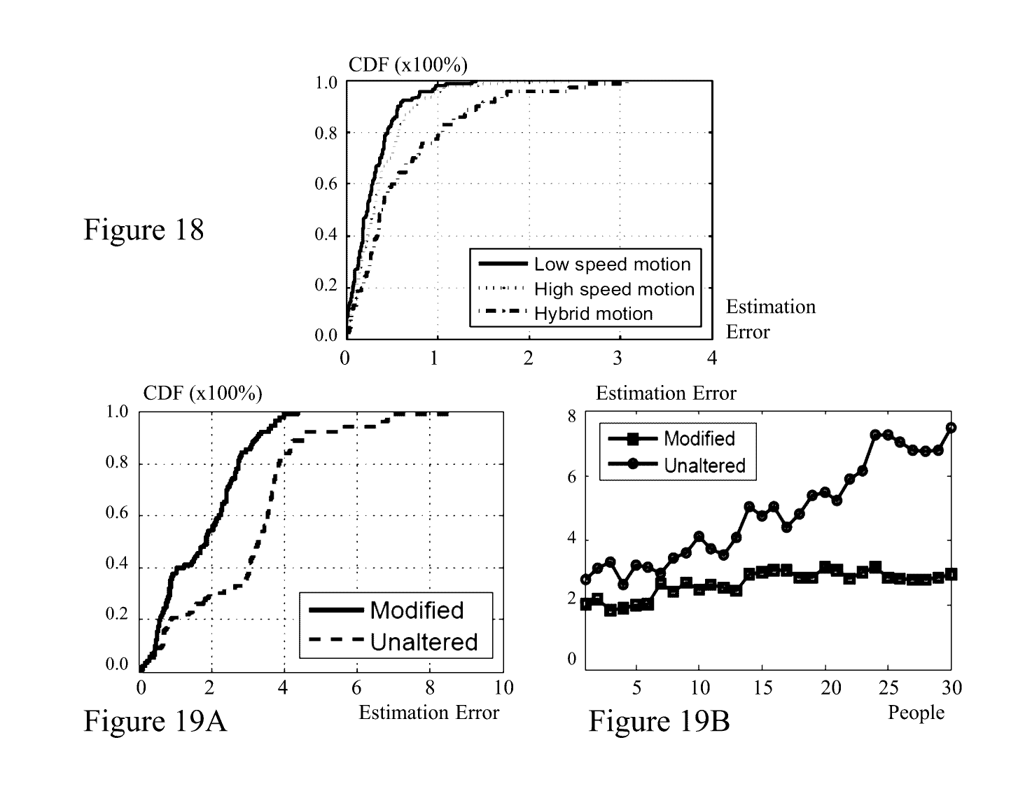

In actual deployed environment, different people will have different walking speeds, as will the same individual in different environments or under different circumstances within the same environment, e.g. hurrying to catch a train in a station versus walking on the platform ahead of the train's scheduled arrival or departure time. Accordingly, the inventors considered whether the speed of movement influences estimation accuracy. Now referring to FIG. 18 there is depicted a plot of the CDF of estimation error in different moving speed. The low speed motion and high speed motion have similar estimation accuracies, but the hybrid motion has larger estimation errors. This is believed to arise as a result of the FCC estimate for the moving people being based on the observation in training phase.

For low speed motion and high speed motion, the training phase and monitoring phase have the same CSI feature. For the hybrid motion, different people have different moving speeds, and the resulting relationship between PEM and the number of moving people is unstable, which will affect the estimation accuracy.

4.7 Scalability in Large Area

Since each receiver can only estimate the number of moving people within a certain range, the scalability of FCC should be considered to work well in large scale scenes. In order to evaluate the scalability of FCC, the inventors implemented a trial system comprising 5 laptops in a hallway, 1 laptop in each corner and 1 laptop in the center as a Tx. Referring to FIGS. 19A and 19B there are depicted the performance comparisons between the unaltered and modified FCC. FIG. 19A shows the CDF of estimation error versus estimation error where in 50% estimation errors are less than 2 using the modified method, while more than 70% errors were more than 2 using unaltered method. FIG. 19B depicts the variation of average estimation error with people increasing from 1 to 30. It is worth noting that the estimation errors remain stable for different number of people using the modified method, while the error is increasing as the number of people increase using unaltered method, especially when the number of people is more than 22. This is because the modified method uses Truncation Denoise Procedure to eliminate distractions among adjacent regions. It is therefore feasible, flexible and extensible. As evident from FIG. 19B FCC works well when 30 people in the scenario, while recent similar work can only distinguish low numbers, essentially no more than 4 people.

4.8: Resolution of Crowd Counting

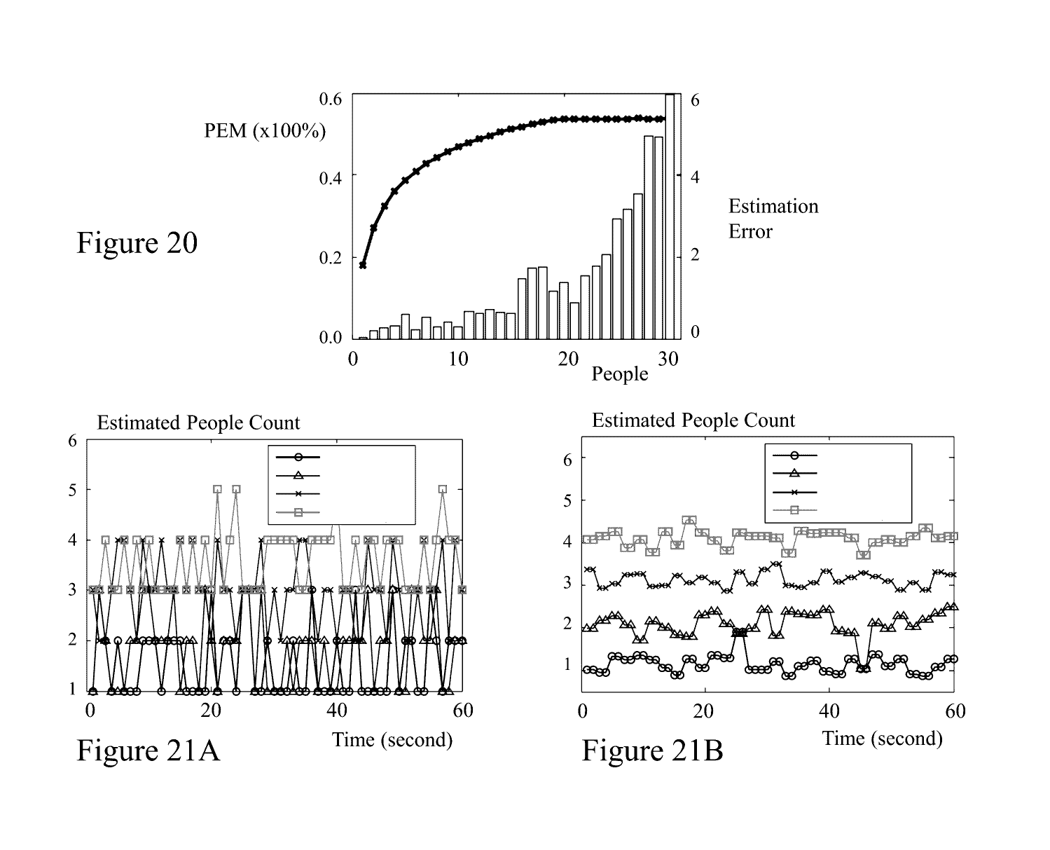

Now referring to FIG. 20 there is depicted the maximum distinguished number of people in the indoor environment. The experiments were again implemented using four laptops in the four corners of a hall. The upper curve plots the PEM variation with the increasing number of people. Obviously, the curve becomes slower gradually when the number of people is more than 20. The bar graph illustrates the average estimation errors. At first, the estimation error is small. When the number of people is more than 15, the estimation error increases to 2. When the number of people increases to more than 27, the estimation increases to more than 5. This is because the PEM almost stops increasing when there are more than 22 people within the environment. Accordingly, the FCC can work well within indoor environments. By contrast, to the knowledge of the inventors, the distinguishability of exist non-vision device-free approaches remains in single digits using a radio link, see Xu et al. in “SCPL: Indoor Device-Free Multi-Subject Counting and Localization using Radio Signal Strength” (Proc. IPSN, 2013), whilst using inverse synthetic aperture radar (ISAR) about 12 people can be established by excessively deploying sensors densely.

4.9: Comparison with Existing Approaches

Within the prior art there are a couple of reported methods of device-free crown counting. Of these, “sequential counting, parallel localizing” (SCPL) is one of the most recent device-free techniques to count and localize multiple subjects in indoor n. Accordingly, the inventors performed some additional experiments to compare the performance of FCC according to an embodiment of the invention against the prior art SCPL. Within these experiments 5 devices were deployed on the both sides of a room with an area of 40 m². Each device is both a transmitter and receiver. Referring to FIGS. 21A and 21B respectively the performance with respect to the people counting results are presented for the prior art SCPL and FCC according to an embodiment of the invention respectively. In all instances, namely with 1, 2, 3, and 4 people the estimated number fluctuates over time for both SCPL and FCC.

The errors are caused by temporally overlapping trajectories and the environmental disturbance. For SCPL, about 45% results are accurate. This arises as the SCPL technique is a link-based scheme, which requires more intensive devices to provide adequate links. For FCC, the estimated results are relative stable. The number of estimated moving people has jitter with a range of approximately ±0.4 within the FCC methodology according to an embodiment of the invention. CSI is information which represents the state of a communication link from the transmit source to the receiver source without requiring any intervening device or limitations arising from the devices carried by the user. It is more sensitive to the diversity of transmission channel than RSS, which makes it more suitable than RSS at counting moving people.

5. Related Work

Recently, the indoor localization and counting problems have attracted much attention. The solutions can be classified into two categories by whether an object needs to carried or not, leading to device-based and device-free methodologies.

5.1 Device-based Approach

Within device-based approaches these utilize device carried by users to locate or count objects. Some systems calculate position relying on coupled RF and ultrasonic signals. Radio frequency identification (RFID) based localization has gained a lot of intention over recent years due to the potential of exploiting low cost RFID tags for inventory management etc. Received signal strength (RSS) based approaches can be categorized into Radio Propagation Model based or Fingerprint based. Recently, Channel State Information (CSI) was used for localization.

However, with the sharply increasing scale of mobile computing, using built-in sensors and modules of smart phones for locating, tracing or counting becomes a wider trend. For example, data collection exploiting Bluetooth environment data has been used for estimating crowd density. Smartphone inertial sensors can also be used for localization. However, such device-based approaches are exactly that, a count of the number of devices. As such the techniques are more suitable for object localization than crowd counting. In many crowd counting scenarios, it is hard to require each person has a device with them. If a person takes more devices or does not carry a device, it will import estimated errors in these techniques.

5.2 Device-Free Approach

Device-free approaches have gained much more attention recently as they do not require targets to equip themselves with devices. The most intuitive device-free solutions exploit machine vision technology but such vision-based crowd density estimations have a considerable overhead of computing and can only work in a line-of-sight pattern. Moreover, because of privacy protection and some other reasons, more focus is now made on non-vision-based approaches. Most of them are built on radio frequency techniques and can be broadly categorized into Location-based scheme and Link-based scheme.

Location-based Scheme: This kind of scheme divides locating procedure into two phases: training phase and operating phase, such as discussed above in respect to embodiments of the invention. Some approaches have sought to formulate the localization problem into a probabilistic classification problem in order to mitigate the error caused by the multipath effect in a cluttered indoor environment in order to locate a single individual. Others have sought to establish relationships between radar charts and crowd movement patterns without significant progress. Such schemes require site surveys over areas of interest to build a fingerprint database with significant manual cost and effort in addition to the resulting inflexibility in respect of environment dynamics. For crowd counting the training costs are too heavy for large scale scenarios and it is hard to obtain the ground truth when the number of people is large.

Link-based Scheme: This kind of scheme exploits that within a communication system, N nodes can construct N(N−1)/2 links. If objects are active nearby Link L_{i,j} then the RSS of Node i and Node j would change obviously. But if an object moves far away from any link, the performance decreases sharply. Obviously, this kind of scheme is more sensitive when the obstacle moves near by the links. Users must deploy exorbitantly intensive nodes to provide adequate links, which causes high cost. If a cell coexists with multiple objects or many objects co-exist in the testing area, the proposed sequential counting algorithm may not effectively estimate the number of people. Utilizing fine-grained physical layer information in localization and counting draws increasing attentions recently.

In contrast the embodiments of the invention exploit CSI measurements on a series of channels between a Tx and one or more Rx. Beneficially, the methodology does not require the individual being counted to have a wireless electronic device at all. Similarly, as the FCC is performed by wireless transmit/receive devices independent of the presence of electronic devices, e.g. PEDs/FEDs associated with the individuals being counted then the wireless system does not need to necessarily conform to a standard or protocol of the electronic devices, e.g. PEDs/FEDs. Accordingly, the FCC system can exploit wireless spectrum not associated with the PEDs/FEDs such that the existing wireless infrastructure capacity for the users being counted is not impacted.

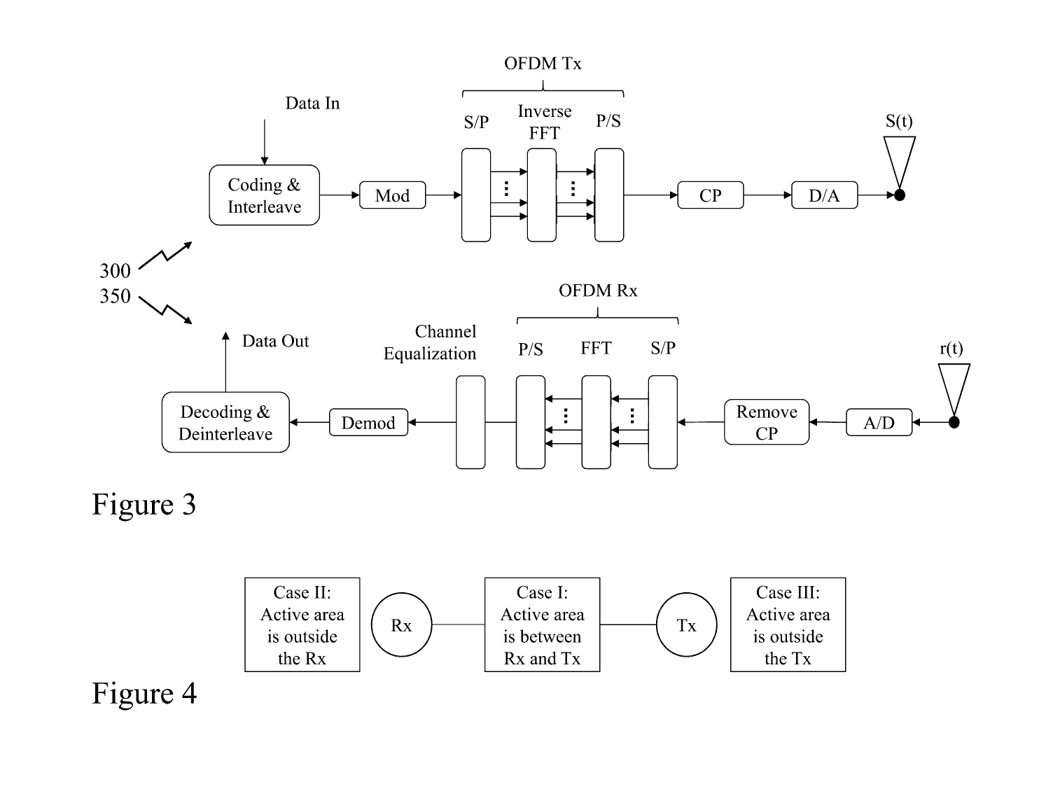

Accordingly, referring back to FIGS. 1 and 2 with respect to the FCC techniques according to embodiments of the invention, as described supra in respect of FIGS. 3 to 18, it would be evident that these may be deployed within a variety of PEDs/FEDs either as discrete standalone crowd counting systems or that these may be integrated with other functionality/systems according to the environment, system requirements, cost, etc. Accordingly, for example, an IEEE 802.11n based system operating at 5 GHz may be deployed to not interfere with user's accessing IEEE 802.11b/g/n at 2.4 GHz with the functionality integrated into the WiFi nodes of the IEEE 802.11 network or alternatively be discrete units or optionally be built into kiosks, terminals, displays, etc. within the indoor environment or within lighting standards and other fixed infrastructure in outdoor environments. Devices may be designed specifically for the crowd counting application or exploit existing consumer devices directly or in stripped/pared down format.

Within the embodiment of the invention described above in respect of FIGS. 3 to 18 the wireless system described and evaluated for CSI information was an OFDM IEEE 802.11n based one. However, it would be evident that other wireless standards may be applied as well as custom wireless systems. In essence as the monitored system does not need to carry real traffic the requirements are that the system provides a plurality of wireless channels simultaneously that can be measured and analysed in order to establish CSI information from which the count is derived. Further, the inclusion of a training process allows such systems to “learn” each deployment environment. In environments that are closed to people at periodic intervals, e.g. night, a holiday, etc. may be periodically re-trained or at least the baseline zero detected individuals be verified.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
processing channel state information for a plurality of wireless channels received at a receiver operating according to a predetermined wireless standard in a first predetermined location within an environment from a transmitter operating according to the predetermined wireless standard in a second predetermined location within the environment; and
determining in dependence upon the processed channel state information (CSI) a count of individuals within the environment.

2. The method according to claim 1, wherein
individuals are counted independent of whether or not they are carrying or have associated with them an electronic device.

3. The method according to claim 1, wherein
the receiver and transmitter are not associated with any of the individuals.

4. A method according to claim 1, further comprising
monitoring a plurality of wireless channels transmitted by the transmitter with the receiver to establish a training data set comprising training CSI data of the plurality of wireless channels; and
processing the training CSI data to establish at least one of a CSI fingerprint and a factor associated with calculating a metric in dependence upon measured CSI data; wherein
determining the count of individuals is made in dependence the processed CSI and at least one of the CSI fingerprint and the factor associated with calculating a metric.

5. A system comprising;
a receiver operating according to a predetermined wireless standard in a first predetermined location within an environment;
a transmitter operating according to the predetermined wireless standard in a second predetermined location within the environment; and
a microprocessor for executing code stored on a non-volatile memory to perform a method, the method comprising the steps:
processing channel state information for a plurality of wireless channels received at the receiver transmitted by the transmitter; and
determining in dependence upon the processed channel state information (CSI) a count of individuals within the environment.

6. The system according to claim 5, wherein
the individuals are counted independent of whether or not they are carrying or have associated with them an electronic device.

7. The method according to claim 5, wherein the receiver and transmitter are not associated with any of the individuals.

8. The system according to claim 5, wherein
the code stored on the non-volatile memory further comprises code for performing additional steps of:
monitoring a plurality of wireless channels transmitted by the transmitter with the receiver to establish a training data set comprising training CSI data of the plurality of wireless channels; and
processing the training CSI data to establish at least one of a CSI fingerprint and a factor associated with calculating a metric in dependence upon measured CSI data; wherein
determining the count of individuals is made in dependence the processed CSI and at least one of the CSI fingerprint and the factor associated with calculating a metric.

9. A method comprising:
receiving at a server connected to a network channel state information for a plurality of wireless channels from a receiver connected to the network operating according to a predetermined wireless standard in a first predetermined location within an environment transmitted by a transmitter operating according to the predetermined wireless standard in a second predetermined location within the environment; and
processing the received channel state information to establish a count of individuals within an environment associated with the receiver.

10. The method according to claim 9, wherein
the server is a cloud server.

11. The method according to claim 9, wherein
the individuals are counted independent of whether or not they are carrying or have associated with them an electronic device.

12. The method according to claim 9, wherein
the receiver and transmitter are not associated with any of the individuals.

13. The method according to claim 9, further comprising
monitoring a plurality of wireless channels transmitted by the transmitter with the receiver to establish a training data set comprising training CSI data of the plurality of wireless channels; and
processing the training CSI data to establish at least one of a CSI fingerprint and a factor associated with calculating a metric in dependence upon measured CSI data; wherein
determining the count of individuals is made in dependence the processed CSI and at least one of the CSI fingerprint and the factor associated with calculating a metric.
